(19) United States
(12) Patent Application Publication
(10) Pub. No.: US 2003/0188751 A1
(43) Pub. Date: Oct. 9, 2003

(54) Inflatable support apparatus

(76) Inventor: Joseph Rogozinski, Ramat Gan (IL)

Correspondence Address: Dekel Patent Ltd., Beit HaRofim, Room 27, 18 Menuha VeNahala Street, Rehovot, IL

(21) Appl. No.: 10/117,995

(22) Filed: Apr. 9, 2002

(51) Int. Cl. A61G 15/00

(52) U.S. Cl. 128/845

(57) ABSTRACT

Inflatable support apparatus (4) comprising at least one inflatable support element (6, 8, 10) comprising a portion adapted to be fit under a groin area of a person, and a carrier (54) attached to said at least one inflatable support element (6, 8, 10) adapted to lift said person supported by said at least one inflatable support element (6, 8, 10), characterized in that said carrier (54) is connected to said at least one inflatable support element (6, 8, 10) by a plurality of straps (72, 80) attached at at least three attachment points to said at least one at least one inflatable support element (6, 8, 10) and at at least two attachment points to said carrier (54); and wherein said at least one inflatable support element (6, 8, 10) defines a plane for supporting said person in standing and walking positions, and an angle of said plane with respect to a horizontal plane is lowerable and raisable by adjusting said straps (72, 80) attached to said two attachment points to said carrier (54).

### FIELD OF THE INVENTION

The present invention relates generally to support aparatus for invalids and the like, and particularly to an inflatable chair or carrier for providing comfortable support to invalids, paraplegics and the like.

### BACKGROUND OF THE INVENTION

It is well known that patients who sit a long time in a wheelchair or lie a long time in bed are vulnerable to various physical dysfunctions. It is important for the patient to undergo therapeutic care while being supported in a standing position.

Many kinds of support apparatus for providing comfortable support to invalids, paraplegics and the like are known. For example, support elements which support the patient from the armpits are known, including inflatable under-the-arm supports. However, such under-the-arm support elements, including the inflatable kind, have disadvantages. First, under-the-arm support elements can put pressure on blood vessels passing through the area, and in certain situations, can block blood circulation. Second, under-the-arm support can interfere with hand movement of the supported patient. Third, the method is ineffective, or even possibly dangerous, for spine-afflicted patients.

Groin support devices are also well known. In general, such devices include straps or sponge paddings placed in the groin area. However, adjustments of groin support devices are generally tiresome to the patient and generally require the patient to be dependent upon attendants to perform the adjustments. Moreover, the straps or paddings tend to move away from their original positions during the course of the patient's activities, and can create localized pressure areas. The pressure areas can cause pain, and in may cases, blockage of blood flow.

### SUMMARY OF THE INVENTION

The present invention seeks to provide a novel, inflatable chair and carrier for providing comfortable support to invalids, paraplegics and the like. The inflatable carrier is superior to the inflatable supports of the art and in particular to the groin supports of the art. The invention supports the patient from under the groin, and enables him/her to stand or walk without any significant disturbance.

The inflatable elements uniquely provide a more uniform distribution of the patient's weight at the groin area, so that localized pressure areas, which could block or restrict blood circulation and cause inconvenience and pain, are not created. The invention obviates the need for adjusting harnesses, paddings or straps. Tests have demonstrated that the invention enabled paraplegics to remain standing more than 45 minutes, wherein most of the patient weight was supported by the inflatable carrier without any interference to the patient functioning. The tests also demonstrated that restricted people, who needed support for part of their weight, succeeded in walking or standing for hours with the inflatable carrier, with reasonable convenience and without limiting their physical and manual activity.

Moreover, in the tests, it was found that no adjustments were necessary from one patient to another. For example, a male adult, height 1.80 m and weight 90 kg, used the same carrier with no adjustments as a femal adult, height 1.50 m and weight 45 kg. Consequently, the patient does not depend on another attendant for adjusting the carrier. The carrier is preferably conveniently and easily opened and closed by means of a single shackle.

It is noted that throughout the specification and claims the term “sit” refers to a situation wherein at least a portion of a patient's weight is supported by support apparatus, including the patient sitting, resting, standing and walking or combination thereof. Throughout the specification and claims the term “lift” refers to support of at least a portion of a patient's weight, no matter whether the patient is raised above a resting surface or whether the patient is touching the resting surface.

### BRIEF DESCRIPTION OF THE DRAWINGS

The present invention will be understood and appreciated more fully from the following detailed description taken in conjunctioin with the drawings in which:

FIG. 1 is a simplified pictorial illustration of inflatable suppport apparatus, constructed and operative in accordance with a preferred embodiment of the present invention;

FIG. 2 is a simplified pictorial illustration of part of a tube with a valve, which serves as an inflatable element in the inflatable suppport apparatus of FIG. 1;

FIG. 3 is a simplified pictorial illustration of the inflatable suppport apparatus of FIG. 1 with a lifting device;

FIGS. 4 and 5 are top-view illustrations of the apparatus of FIG. 3, respectively with four and six mutually spaced, inflatable elements;

FIG. 6 is a simplified pictorial illustration of a lifting device for lifting the inflatable suppport apparatus of FIG. 1, constructed and operative in accordance with a preferred embodiment of the present invention;

FIG. 7 is a simplified pictorial illustration of a frontal connecting device of the lifting device of FIG. 6;

FIG. 8 is a simplified pictorial illustration of the lifting device of FIG. 6 lifting or supporting a patient, in accordance with a preferred embodiment of the present invention;

FIG. 9 is a simplified pictorial illustration of inflatable suppport apparatus, constructed and operative in accordance with another preferred embodiment of the present invention, comprising a single inflatable element;

FIG. 10 is a simplified pictorial illustration of inflatable suppport apparatus, constructed and operative in accordance with yet another preferred embodiment of the present invention, comprising a modular seat;

FIG. 11 is a simplified pictorial illustration of the lifting device of FIG. 6 and inflatable support apparatus of FIG. 1 lifting or supporting a patient, in accordance with a preferred embodiment of the present invention; and

FIGS. 12A and 12B are simplified pictorial illustrations of inflatable suppport apparatus, constructed and operative in accordance with another preferred embodiment of the present invention, comprising control apparatus, respectively before and after lifting a patient to a standing position.

### DETAILED DESCRIPTION OF A PREFERRED EMBODIMENT

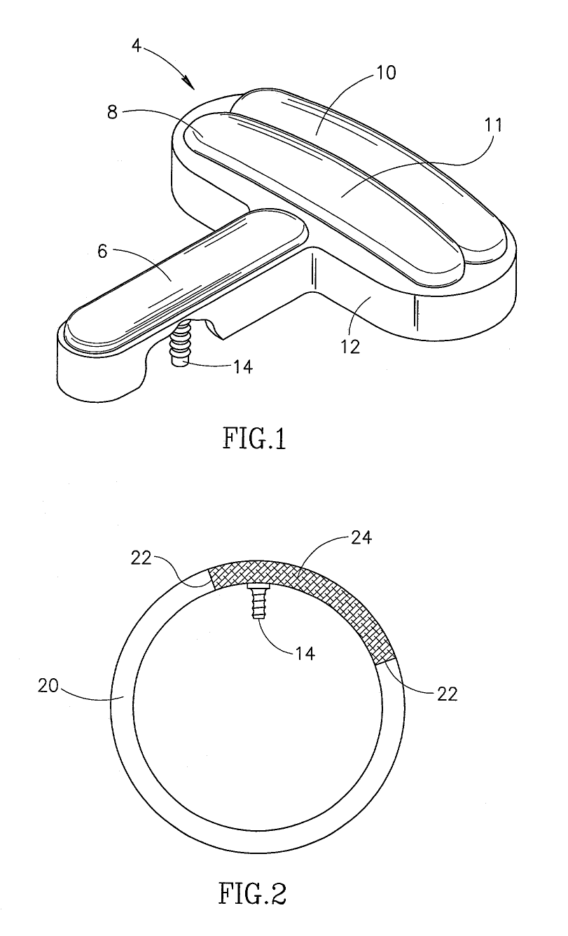

Reference is now made to FIG. 1 which illustrates inflatable suppport apparatus 4, constructed and operative in accordance with a preferred embodiment of the present invention. Apparatus 4 preferably includes one or more inflatable elements, such as a longitudinal inflatable element 6, an inner transverse inflatable element 8, and an outer transverse inflatable element 10, connected to a common base 12.

One or more valves 14 are preferably provided for inflating the inflatable elements. A single valve 14 can be dedicated for inflating only one inflatable element, in which case the inflatable elements can be inflated to different, individual pressures. This can be advantageous to customize the supportive air pressure to a particular patient's needs. Alternatively, one valve 14 can be used to inflate all of the inflatable elements with the same pressure.

The inflatable elements may be inflated by any fluid, such as a gas (e.g., air, nitrogen) or a liquid (e.g., water) or a mixture of a liquid and gas. The fluid used to inflate the inflatable elements may have different viscosities for different supporting properties.

The inflatable elements are preferably covered with a covering 11. Covering 11 may comprise sewn fabric sleeves, with the inflatable elements inserted into the sleeves. Covering 11 helps aesthetically to keep the inflatable elements in their correct places. Alternatively, the inflatable elements may be made of an elastomer, such as rubber, and have no covering.

Reference is now made to FIG. 2 which illustrates one way of constructing longitudinal inflatable element 6. It is appreciated that the inflatable elements can be constructed in other manners as well. In the illustrated embodiment, longitudinal inflatable element 6 is constructed from a bicycle tube 20, cut at positions 22, thereby forming a clipped tube 24 with valve 14 protruding therefrom. The clipped tube 24 is then sealed at positions or ends 22 to form with longitudinal inflatable element 6.

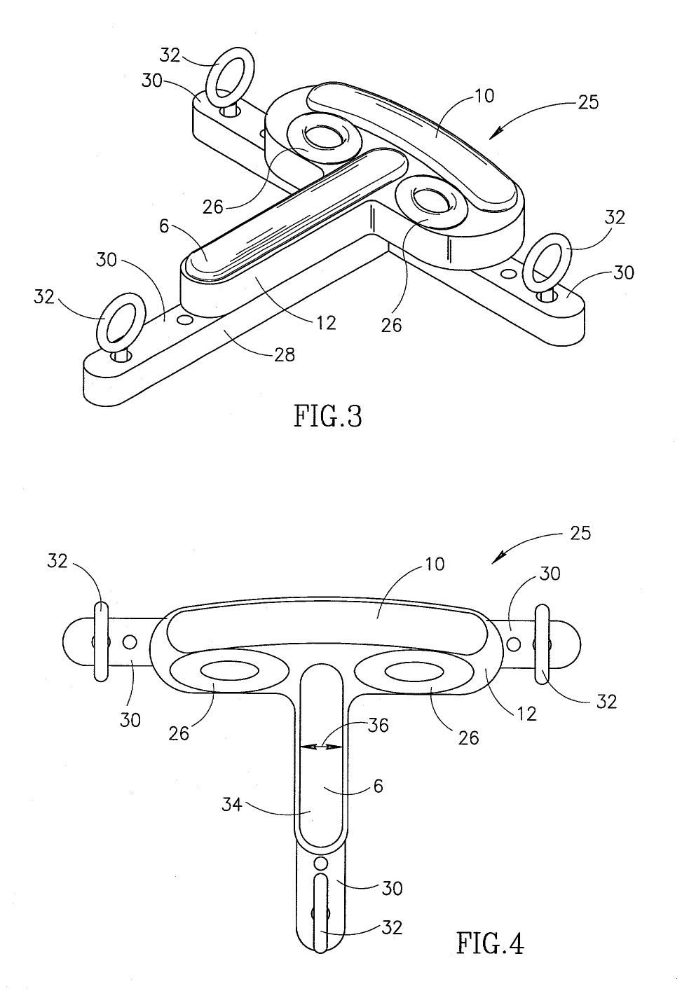

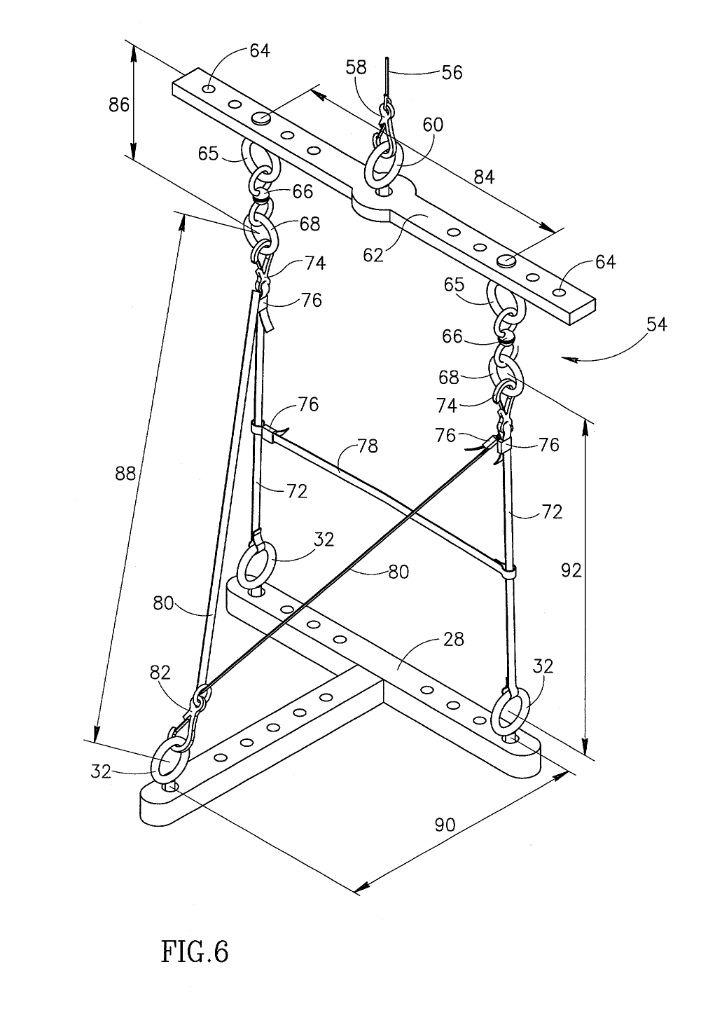

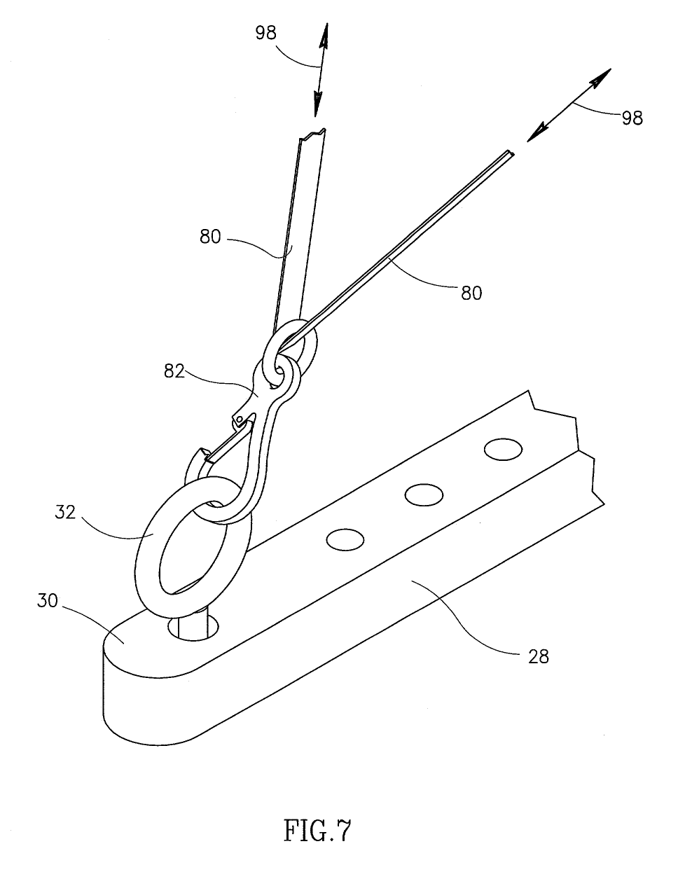

Reference is now made to FIG. 3 which illustrates inflatable suppport apparatus 4 with a lifting device 25. In this illustrated embodiment, support apparatus 4 has a pair of outer transverse inflatable elements 26. Inflatable suppport apparatus 4 is preferably mounted on a base 12. Lifting device 25 preferably includes a T-shape support 28, made of any sturdy material, such as metal, wood or structural plastic, for example. Base 12 is preferably placed and connected to T-shape support 28. The main purpose of support 28 is to enable connection to a lifting device, as is explained further hereinbelow with reference to FIG. 6.

Support 28 is preferably formed with three tapped holes 30, at each of the three extremities of support 28. A lifting ring 32 is preferably threadedly attached to each of holes 30, and secured by self-lock nuts, for example. Rings 32 are preferably free rotating. Referring additionally to FIG. 4, it is seen that a front part 34 of inflatable element 6, base 12 and support 28, preferably has a relatively narrow width 36 in order to enable easy and convenient insertion between a patient's feet at the groin. The narrow width 36 enables the patient to walk or stand with minimal disturbance. The narrower the width, the more confortable it is to walk or stand. However, the width 36 cannot be too narrow because too narrow a width can cause high pressure at the groin area of the patient. Thus, it is most preferable to optimize the width 36 can be optimized to suit the patient.

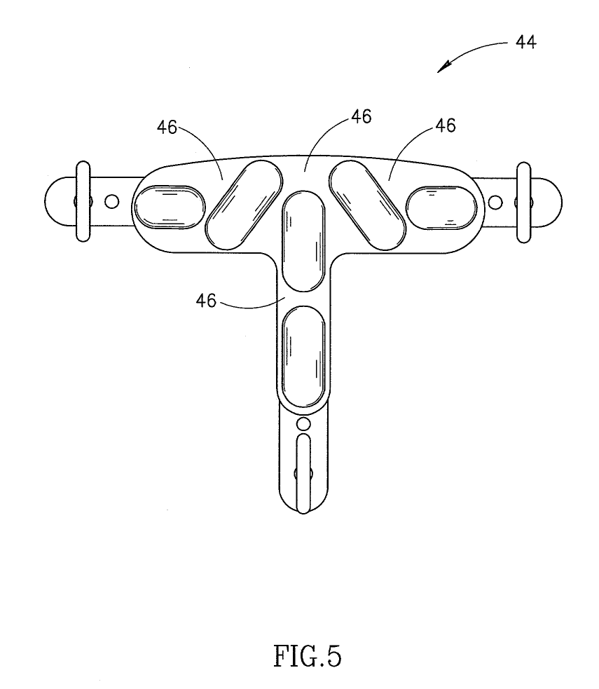

In FIG. 4, there are four mutually spaced, inflatable elements. In FIG. 5, another embodiment is shown with six inflatable elements 44 with spaces 46 between each of the elements. During tests, it was discovered that the size and number of spaces 46 between inflatable elements 44 have a significant effect on the distribution of load of the patient. It was also found that a single inflatable element, while succeeding to support the patient in a walking or standing position, is not as effective as a plurality of elements.

Reference is now made to FIG. 6 which illustrates a lifting device or carrier 54 for lifting inflatable suppport apparatus 4 (FIG. 1), constructed and operative in accordance with a preferred embodiment of the present invention.

Carrier 54 preferably includes a lifting ring 60 journaled in an upper beam 62, such that beam 62 and ring 60 can freely swivel with respect to each other, even more than 360°. Carrier 54 can be supported and lifted by means of a cable 56 and shackle 58 connected to any mobile crane, tracked crane or any other lifting mechanism. Beam 62 is preferably formed with two groups of attachment holes 64, formed on either side of lifting ring 60. Attachment holes 64 may be symmetrically arranged about lifting ring 60. Threaded rings 65 are preferably attached to holes 64. It is noted that rings 65 may be attached to beam 62 symmetrically about lifting ring 60, or alternatively, may be attached asymmetrically about lifting ring 60. The latter case may be beneficial for a patient who is partly paralyzed, or limited in standing or walking, wherein one side of the patient is weaker than the other.

A pair of rear straps 72 are preferably secured to rear rings 32 of support 28. Ends of straps 72 are preferably secured to shackles 74 which hook on to rings 68 which are connected to rings 65 by means of chains 66. (Support 28 supports apparatus 4 thereupon, but apparatus 4 is not shown in FIG. 6 for the sake of clarity.) Buckles 76 are preferably attached to straps 72 for adjusting the length of the straps 72. A transverse strap 78 is preferably attached, such as by sewing, to the rear straps 72. The length of transverse strap 78 is also preferably adjusted by another buckle 76. Transverse strap 78 serves, inter alia, to support the patient from the rear side, in the event of loss of balance, or during transition from sitting to standing, and vice versa.

A front strap 80 preferably is looped through a front shackle 82 hooked on to the front ring 32 of support 28. In this manner, carrier 54 is preferably conveniently and easily opened and closed by means of the single front shackle 82. (Alternatively, two separate straps may be used in place of the single strap 80.) FIG. 7 illustrates tensile forces 98 set up in front strap 80. The length of front strap 80 is also preferably adjusted by another buckle 76. The system of rear straps 72 and front strap 80 unambiguously defines a plane (because three points define a plane), for the patient to be supported by support 28 and inflatable support apparatus 4. The significance of the unambiguously defined plane in supporting the patient is discussed hereinbelow. It is noted that instead of the three-point support, a four-point (or more) support can be used, but is more complicated and less preferred.

The front part of the support plane can be raised by shortening the length 88, which is the half length of front strap 80. Conversely, the front part of the support plane can be lowered by lengthening the length 88. Other dimensions which can be adjusted include width 84 between holes 64, height 86 between beam 62 and ring 68, length 90 between the front ring 32 and the rear rings 32, and length 92 of strap 72.

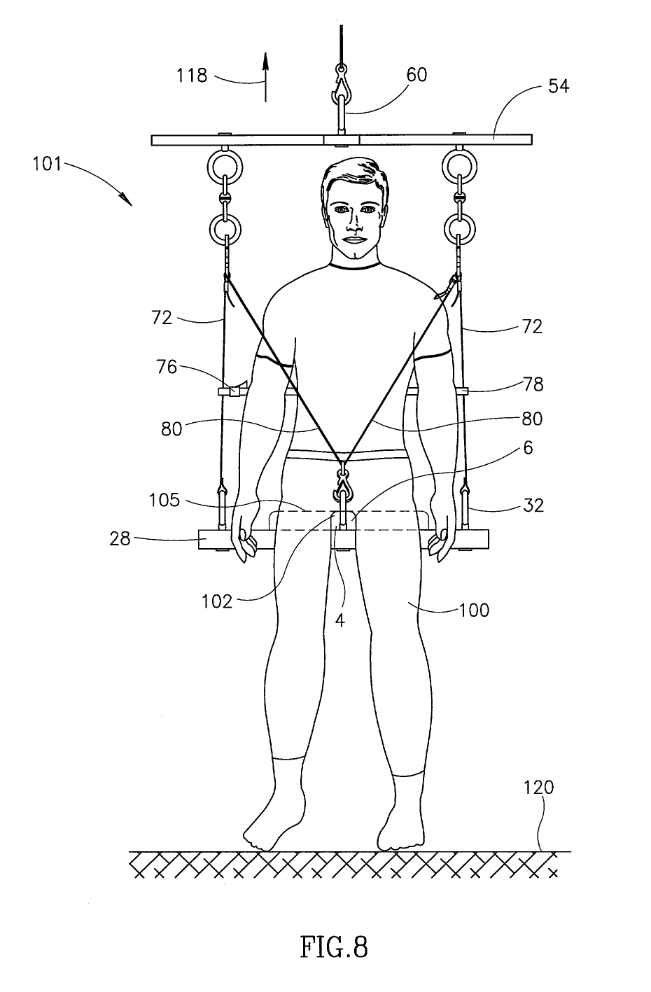

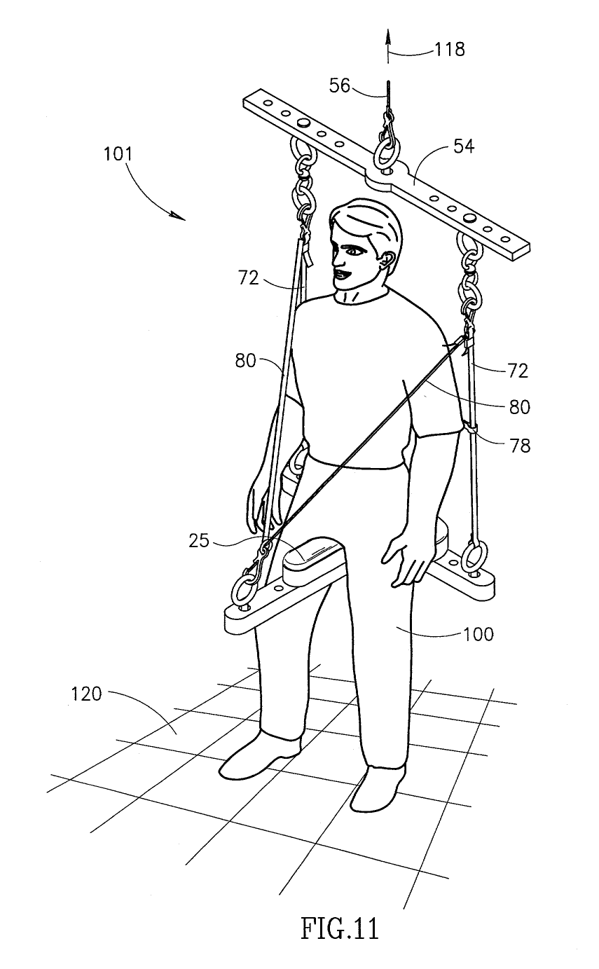

Reference is now made to FIGS. 8 and 11 which illustrate lifting device 54 lifting or supporting a patient 100 standing or walking on a surface 120, in accordance with a preferred embodiment of the present invention. The entire carrier assembly is referenced by reference numeral 101. Longitudinal inflatable element 6 (FIGS. 1 and 3) supports patient 100 at a groin area 102. An area 105 (shown by a hidden line), represents the support of the inner transverse inflatable element 8 and the outer transverse inflatable element 10 (FIGS. 1 and 3. The lifting force on carrier 54 is generally in the direction of an arrow 118. Additional straps may be provided at the sides of patient 100, if needed, to provide extra security against falling sideways. In the illustrated configuration, it is possible to support patient 100 with different forces, depending upon whether patient 100 is standing or walking.

The arrangement of the straps and their attachment to support 28, provide statically balanced support to patient 100 at all times because:

a) the center of gravity of patient 100 is below the suspension point (at ring 60 and shackle 58),

b) the attachment of the straps to rings 32 unambiguously defines a support plane, and

c) the center of gravity is situated generally over the longitudinal axis of longitudinal inflatable element 6.

As mentioned hereinabove, the front part of the support plane can be raised by shortening the length 88, which is easily accomplished by merely adjusting the single buckle 76 attached to front strap 80. The raising of the front part of the support plane means that the support plane rotates about an imaginary axis extending between the rear rings 32. This raising of the front part of the support plane may be important in preventing slipping of the patient, for example. Even after raising or lowering the front part of the support plane, patient 100 remains statically balanced and supported.

The inflatable support apparatus of the present invention can also be used as part of a rescue device. For example, cable 56 may be connected to a helicopter fro raising persons to be rescued. The inflatable support apparatus provides constant, balanced support to the rescued person. If the apparatus is inflated with air, the apparatus can float in water, making the apparatus ideal for marine rescue missions.

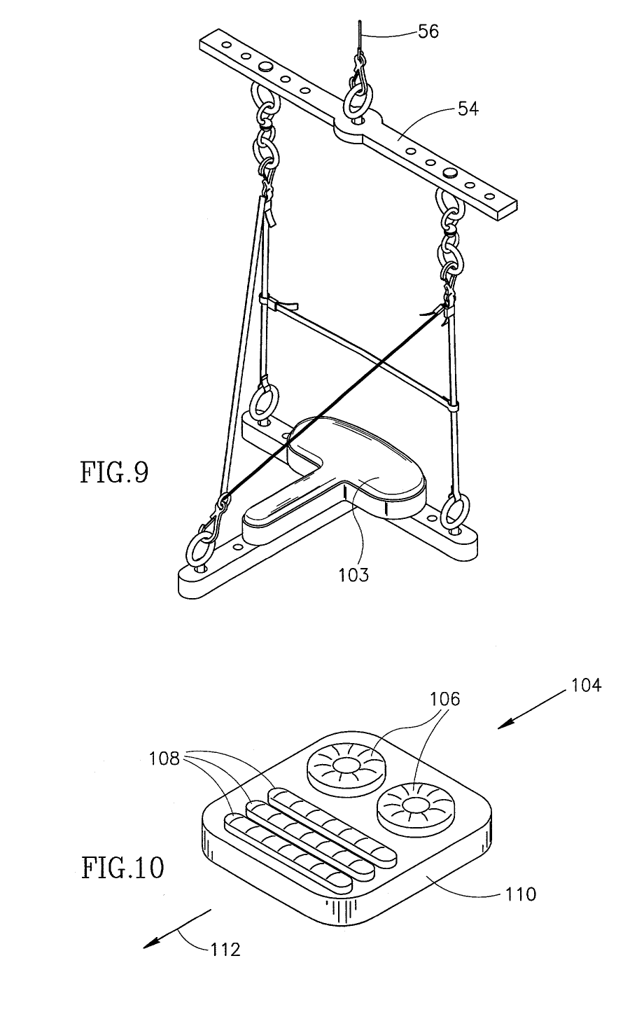

Reference is now made to FIG. 9 which illustrates the inflatable suppport apparatus 4 constructed with a single inflatable element 103. As mentioned above, it was found in testing that a single inflatable element, while succeeding to support the patient in a walking or standing position, is not as effective as a plurality of elements.

Reference is now made to FIG. 10 which illustrates inflatable suppport apparatus, constructed and operative in accordance with yet another preferred embodiment of the present invention. The embodiment includes a modular seat 104 having one or more inflatable elements 106 (two shown in the illustration) with a relatively large area to support the bottom area of a patient. Modular seat 104 preferably includes one or more transverse, elongate inflatable elements 108 (three shown in the illustration), to support the patient's upper leg area. The inflatable elements 106 and 108 are preferably mounted on a common base 110. The sitting direction of the patient is indicated by an arrow 112. The modular seat 104 may be used in a variety of applications, other than being integrated in support apparatus 4, such as supporting workers working at heights, or for supporting mountain climbers. Modular seat 104 can be placed upon support 28 (FIG. 3), or it can be placed on an ordinary chair, for example.

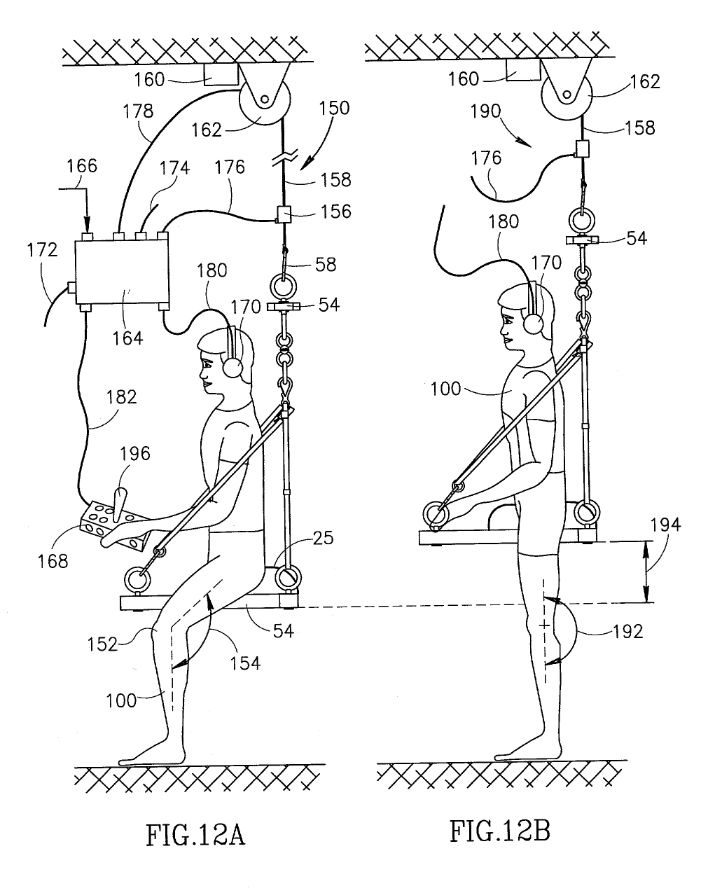

Reference is now made to FIGS. 12A and 12B which illustrate control apparatus useful with inflatable suppport apparatus 4. In FIG. 12A, the control apparatus is shown in a configuration designated by reference numeral 150, wherein patient 100 is sitting on apparatus 4 supported by carrier 54, with knees 152 bent at an angle 154. Carrier 54 is supported by a shackle 58, which is connected by a cable 158 to a load cell 156. Cable 158 is preferably connected to a drive system 160 by means of a pulley 162. Drive system 160 is capable of raising and lowering patient 100.

A control box 164 receives electric power through a feed cable 166. Patient 100 preferably holds a switch box 168 with a joystick 196. Patient 100 preferably wears a headphone 170. Control box 164 is preferably connected to load cell 156, drive system 160, headphone 170, joystick 168, an external computer and a processor (both not shown), respectively by means of cables 176, 178, 180, 182, 174 and 172.

In FIG. 12B, the control apparatus is shown in a configuration designated by reference numeral 190, wherein patient 100 stands while supported by carrier 54. Patient 100 stands at an angle 192, which is nearly 180°. The difference in height between the sitting and standing positions is indicated by reference numeral 194. Lifting and lowering patient 100 to and from the standing position flexes the patient's knees as part of a therapeutic plan.

The therapeutic plan may be carried out by means of a number of the illustrated devices. For example, joystick 196 may be used to select a lifting or lowering mode, velocity, height, etc. Similarly, instead of joystick 196, various control buttons may be pressed. The joystick 196 or control buttons preferably cause control commands to be performed in accordance with a therapeutic plan that has been programmed into the control system comprising drive system 160 and control box 164. As another example, sensors placed on patient 100 may be in communication with control box 164 and drive system 160, wherien biofeedback is used to control lifting lowering the patient. Headphone 170 itself may serve as a biofeedback sensor for this purpose. Other sensors which may be used include, for example, pulse sensors, persipration sensors, temperature sensors, breathing sensors and the like. As another example, a medical operator may instruct patient 100 (the commmand being heard in headphone 170) to flex knees 152 through some angle, such as 120°.

The control system may be integrated with mobile cranes, with a built-in control system, for raising and lowering patient 100 by cable 158. When designing the therapeutic plan, the system can take into account various parameters, such as patient weight, maximum lifting and lowering values, maximum velocity, residual force on the floor, frequency of operation, and angle of knee flexure, just to mention some.

As seen in FIG. 12A, in the sitting position, the feet of patient 100 touch the floor. Because of the structure of inflatable support apparatus 4, patient 100 can rotate himself/herself about the axis of cable 158. Patient 100 can also do pendulum movements with his/her feet. It is to be emphasized that the movement and flexure of the knees and activation of the foot muscles are very important, especially for invalids sitting or lying in bed for long periods of time. The flexure and activation significantly reduce muscle degeneration.

It will be appreciated by person skilled in the art, that the present invention is not limited by what has been particularly shown and described herein above. Rather the scope of the present invention is defined only by the claims which follow:

What is claimed is:

1. Inflatable support apparatus (4) comprising:
at least one inflatable support element (6, 8, 10) comprising a portion adapted to be fit under a groin area of a person; and
a carrier (54) attached to said at least one inflatable support element (6, 8, 10) adapted to lift said person supported by said at least one inflatable support element (6, 8, 10);
characterized in that said carrier (54) is connected to said at least one inflatable support element (6, 8, 10) by a plurality of straps (72, 80) attached at at least three attachment points to said at least one at least one inflatable support element (6, 8, 10) and at at least two attachment points to said carrier (54); and
wherein said at least one inflatable support element (6, 8, 10) defines a plane for a supporting said person in standing and walking positions, and an angle of said plane with respect to a horizontal plane is lowerable and raisable by adjusting said straps (72, 80) attached to said two attachment points to said carrier (54).

2. Apparatus (4) according to claim 1 wherein said straps (72, 80) unambiguously define a plane for supporting said person.

3. Apparatus (4) according to claim 1 wherein said at least one inflatable support element (6, 8, 10) has a front portion and a rear portion, wherein said front portion is narrower than said rear portion.

4. Apparatus (4) according to claim 1 wherein an upper portion of said carrier (54) is attachable to a support structure by at least one attachment point.

5. Apparatus (4) according to claim 1 wherein said straps comprise a transverse strap (78) attached to at least one of said straps (72), said transverse strap (78) being adapted to support the patient from a rear side thereof.

6. Apparatus (4) according to claim 1 wherein a front portion of said at least one inflatable support element (6, 8, 10) is higher than a rear portion of at least one inflatable support element (6, 8, 10).

7. Apparatus (4) according to claim 1 wherein said at least one inflatable element (6, 8, 10) is inflated with at least one of a gas and a liquid.

8. Apparatus (4) according to claim 1 and comprising a plurality of said inflatable elements (6, 8, 10) wherein one of the inflatable elements (6, 8, 10) is inflated to a different pressure than another of the inflatable elements (6, 8, 10).

9. Apparatus (4) according to claim 1 wherein said carrier (54) comprises a T-shape support adapted for supporting a person in a groin area thereof.

10. Apparatus (4) according to claim 1 and further comprising control apparatus connected to said inflatable support apparatus.

11. Apparatus (4) according to claim 10 wherein said control apparatus comprises a drive system operative to raise and lower a person.

12. Apparatus (4) according to claim 10 wherein said control apparatus comprises a control box connected to at least one of a load cell, a drive system, a headphone and a joystick.

13. Apparatus (4) according to claim 10 wherein said control apparatus comprises a biofeedback sensor.

14. Apparatus (4) according to claim 10 wherein said control apparatus is adapted to take into account at least one of the following: patient weight, maximum lifting and lowering distances, maximum velocity, residual force on a floor, frequency of operation, and angle of knee flexure.
